(19) United States
(12) Patent Application Publication
(10) Pub. No.: US 2005/0080773 A1
(43) Pub. Date: Apr. 14, 2005

(54) Network drawing system and network drawing method

(76) Inventors: Asako Koike, Matsudo (JP); Yoshiki Niwa, Hatoyama (JP); Toshihisa Takagi, Tokyo (JP)

Correspondence Address: REED SMITH LLP, 3110 Fairview Park Drive, Suite 1400, Falls Church, VA, 22042, US

(21) Appl. No.: 10/766,561

(22) Filed: Jan. 29, 2004

(30) Foreign Application Priority Data
Oct. 14, 2003 (JP) 2003-353097

(51) Int. Cl. G06F 17/30

(52) U.S. Cl. 707/3

(57) ABSTRACT

Data newly obtained on genes by experiments, data obtained from texts and data obtained through the Internet or the like are integrated to provide novel knowledge. Information on the association between terms such as a gene, a compound, a disease, gene functions and the like accumulated in a data storage system is used to reconstruct a network of terms connecting a first query and a second query designated by a first query input unit l so to display on a display device. Thereby, a term associating the first query and the second query is displayed. As a result, a user is provided with knowledge how the first query and the second query are associated.

### FIELD OF THE INVENTION

The present invention relates to a network drawing system and its method for supporting the configuration of a network between terms according to information on relationships of keywords, data and the like accumulated in a database.

### BACKGROUND OF THE INVENTION

Generally, in a field of searching for information, the searched result having a high relationship with a key word is extracted based on a retrieval key such as a key word, and the extracted result is shown on a screen. For example, WO01/020535 describes that biological data is searched by various searching methods using plural databases.

Meanwhile, information on genes and diseases are increasing by rapid advancement of molecular biology and complete decoding of genomes in these years. But, knowledge accumulated in texts and newly obtained experimental results were separately handled, and there was substantially no means available for automatic integration of them. Especially, there was no means in fields of linkage analysis and association study, which were desired to be progressed upon the complete decoding of genomes. Therefore, even if a chromosome site to be a candidate for a disease gene was limited in the fields of linkage analysis and association study, it was often that the number of genes present in the range of candidate was not less than 100. It was common that researchers read each text to see what functions a gene to be the candidate had, studied and estimated the disease gene, and selected the next experiment step. And, for clustering of information on expression of a DNA-array and a protein-array, adequacy of clustering was judged by researchers who read texts to see whether the gene in the clustering was the one on which the relationship has been pointed out in the past.

### SUMMARY OF THE INVENTION

It is considered that, with the progress of future researches, many different types of experiments will be conducted on protein-protein information, gene/protein expression information, transcription factor information and the like in especially the field of biotechnology, and enormous results will be accumulated. Therefore, the researchers need to consume enormous energy to searching texts and the like in order to obtain biological knowledge in view of the relationship between data obtained by new experiments and already available information.

It is an advantage of the present invention to enhance an efficiency of searching texts so to make it easy for a searcher to obtain information on the relationship between terms.

To achieve the above-described advantage, the present invention specifies a term group 1 and a term group 2 of which relationship a user desires to know so to use the relationship between the previously accumulated terms or the relationship between the terms obtained by dynamically accessing through the Internet and shows how the term groups 1 and 2 are associated. Thus, the researcher can obtain new biological knowledge by combining the experimentally obtained information and the shown information without reading each text.

Specifically, according to one embodiment of the present invention, there is provided a network drawing system, comprising a first input part designating a first query belonging to a first category; a second input part designating a second query belonging to a second category; a data storage device storing a degree of association between terms belonging to a third category containing the second category and the first category and its attributes as plural sets in a table form; a calculation device using the table stored in the data storage device to associate the input first query and second query through plural terms; and a display device displaying on a screen a network to connect the first query and the second query through the plural terms according to the result of calculation made by the calculation device. Besides, a third input part for specifying a search condition may also be disposed.

For example, it is considered that the first category includes compounds, disease names, disease symptoms, protein/gene names and the like and the second category includes compounds, protein/gene names and the like, but they are not limitative, and terms related to the two term groups in which the user has an interest are also included. Other than the biological category, for example, the first category may include a failure symptom of equipment, the second category may include a model of equipment, and the first and second categories are connected by a noun phrase of the cause of a failure, so that the relationship between the failure symptom and the cause of a failure of each model can be seen roughly. It is also possible to know what relationship exists between a politician's name placed in the first category and a government office's name placed in the second category (in this case, the terms connecting the network correspond to all noun phrases). It is also possible to place a foreign country's town name in the first category and a Japan's town name in the second category and to connect those towns by a similarity. And, the first category may include a key word of a patent text and the second category may include a key word of a thesis.

Here, the relationship between terms include all what can be obtained by analyzing data and texts published on the Web. Extraction of data from texts includes one made after reading by a person and one made automatically by machine-processing such as natural language processing. The extraction of the relationship between terms by the natural language processing is mainly made according to the co-occurrence, phrase patterns and the like.

The network between terms is drawn considering a weight of information between the above-described terms (relationship between terms). The shortest distance of terms between two points is described according to a dijkstra method or an evaluation and review technique. The distance here is defined by a function that the distance between terms becomes short, as the shortest distance with a high degree of association between terms is higher. It does not always become a path for the most important term, so that it is desirable to show some candidates having a high score.

And, the path with the highest degree of association between terms can also be shown by a highlight line.

Besides, calculation of the shortest distance by the dijkstra method or the like takes a long time when the distances of all points are calculated. Therefore, it is desired to trim appropriately upon the specification by the user so not to calculate the distance between terms which is further than a threshold value. This threshold value can be specified from the third input part. When the number of target terms is many, the calculation time can be made short by previously restricting the maximum steps (the number of terms entering between them) connecting the first query and the second query by the third input part.

According to the present invention, for example, when a lod score is obtained by a linkage analysis and a region of genes to be the candidates for the disease gene is determined, the known knowledge can be summarized from it to provide as the disease gene the most reasonable gene or gene group.

According to the present invention, by displaying the network of terms together with the results of gene/protein clustering of a DNA array and a protein array, the gene/protein configuring the cluster that seems to be noise caused by experiments can be presented.

According to this system, when an edge connecting terms is clicked, a magazine name that is the source of data indicating the relationship between terms, a sentence from which information is extracted, an abstract and a database name can be presented. And, when a node is clicked, the attributes of each term, for example, subcellular localization and expression information can be read when the term is protein.

According to the present invention, when the term group used as the term has hierarchy like gene ontology (http://www.geneontology.org/) and a family name, drawing the network in an upper hierarchy allows to show the network concisely, to show considering the relationship between terms with a low expression frequency and statistical uncertainty, or to show the network with the node (term) connecting conditions eased.

Meanwhile, when data indicating the association of gene/protein relating to the focused living species is little, this system can connect orthologous or similar gene/protein between another living species and the focused living species by a sequence analysis to construct the network by using information on the other living species. Specifically, information on other living species, sequence similarity, domain composition information and the like are used.

According to the present invention, it is also possible that the connection (edge) between the inappropriate terms or the removal of terms themselves are made by addition of an editing function to the network drawing system, or the network is interactively reconstructed by connection between terms seemed being in short or addition of terms themselves.

As described above, according to the present invention, the relationship between terms can be known by using information having information between terms accumulated as the binary relation and its attributes to indicate the network of terms connecting the query 1 and the query 2. Thus, it becomes easy to find relationships with a concept (term), which was considered not having relationships, and convenience of retrieval is enhanced.

Other objects, features and advantages of the invention will become apparent from the following description of the embodiments of the invention taken in conjunction with the accompanying drawings.

### BRIEF DESCRIPTION OF THE DRAWINGS

FIG. 1 is a system configuration diagram showing one example of the term network system according to the present invention;

FIG. 2 shows a procedure of using the system of FIG. 1;

FIG. 3 shows a procedure of extracting data on automatic extraction from data to be stored in the data storage system according to the present invention;

FIG. 4 shows an example of information on a binary relation to be stored in the data storage system according to the present invention, corresponding to reference numeral 42 in FIG. 1;

FIG. 5 shows information on appearance in texts having terms for calculation of co-occurrence to be stored in the data storage system according to the present invention, corresponding to reference numeral 41 in FIG. 1;

FIG. 6 shows attributes of terms configuring a binary relation to be stored in the data storage system according to the present invention, corresponding to reference numeral 44 in FIG. 1;

FIG. 7 shows text information to be attributes of the binary relation to be stored in the data storage system according to the present invention, corresponding to reference numeral 44 in FIG. 1;

FIG. 8 shows a hierarchical relationship of terms to be attributes stored in the data storage system according to the present invention, corresponding to reference numeral 44 in FIG. 1;

FIG. 9 is a diagram of a data display example according to the present invention, showing a network of terms described on all focused terms;

FIG. 10 is a diagram of a data display example according to the present invention, showing an example described in an upper concept (term) using information corresponding to that of FIG. 8;

FIG. 11 is an example of a score in the network of terms and a lod score by the linkage analysis superposed, corresponding to step 7 (reference numeral 25) in FIG. 2;

FIG. 12 is an example of a network of terms at a portion where both the score and the lod score in the network of terms are high in FIG. 11, corresponding to step 8 in FIG. 2;

FIG. 13 is an example of drawing a network of terms between the query 1 and the clustering according to expression data of a DNA array and the genes configuring the clustering, corresponding to step 9 (reference numeral 29) in FIG. 2;

FIG. 14 is a diagram showing an input screen; and

FIG. 15 is a diagram showing a flow of search in an example.

### DETAILED DESCRIPTION OF THE EMBODIMENTS

One embodiment of the present invention will be described in detail with reference to the accompanying drawings. It is to be understood that the invention is not limited to the following examples unless they exceed the purpose of the invention.

### EXAMPLE 1

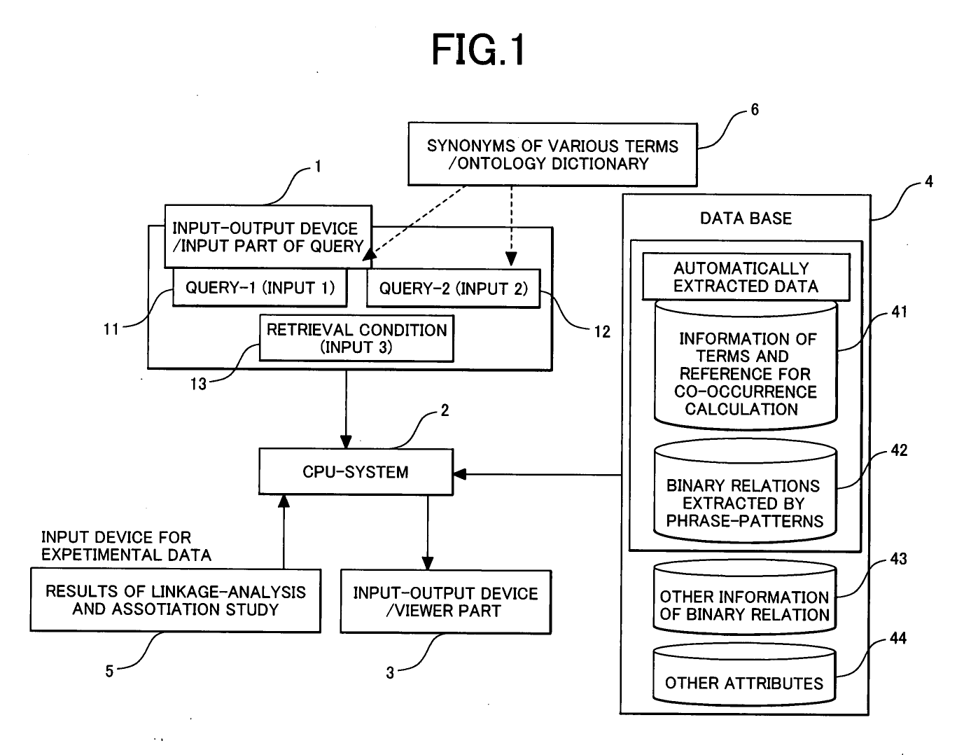

FIG. 1 is a system configuration diagram showing one example of the embodiments of the term network system according to the present invention. The term network system comprises an I/O device/query input part 1, a CPU system 2, an I/O device/display part (unit) 3 and a data storage system (databease) 4. An experiment data input device 5 is added if necessary. It is more desirable that a dictionary 6 for converting the queries into standardized terms is provided in order to remedy the problems of synonym of the used terms.

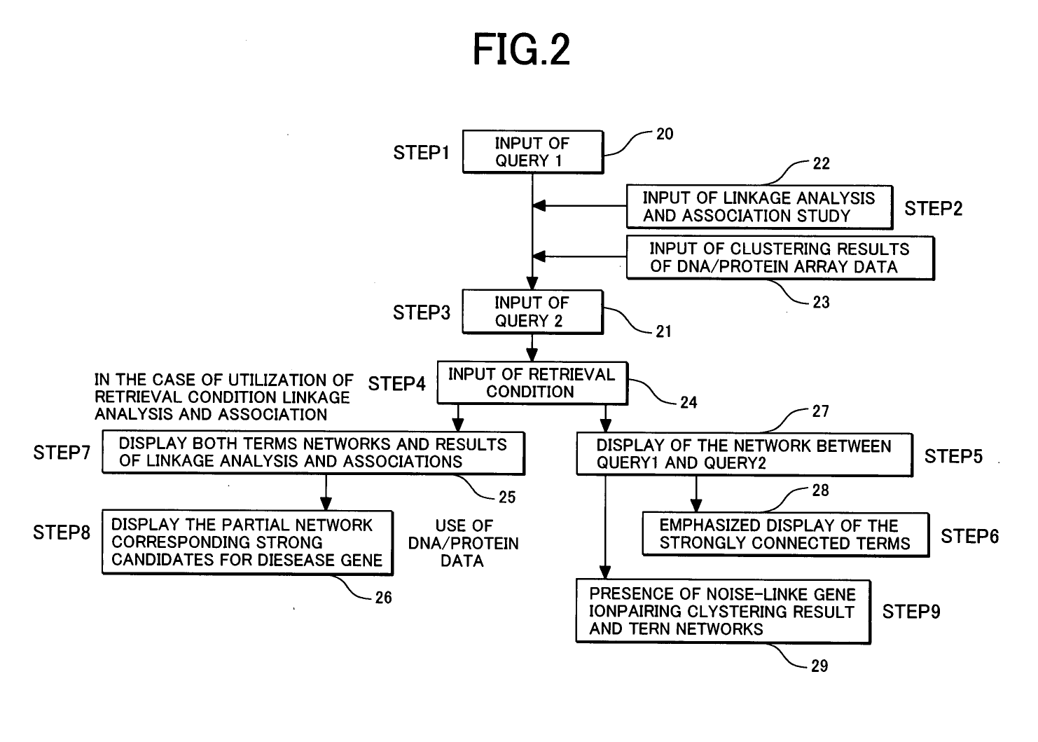

A method of using this system is shown in FIG. 2. A table in which binary relation/multinominal relation manually or automatically extracted from texts and various types of databases and information on its degree of association are accumulated and/or a table in which terms for calculating the co-occurrence and information on its texts are accumulated, and the terms or attributes between the terms are accumulated in the data storage system 4 of FIG. 1. The term group query 1 (step 1 of FIG. 2) and query 2 (step 3 of FIG. 2), which are designated by the input part 1 of FIG. 1, are combined under search conditions (an input part 13 of FIG. 1 and step 4 of FIG. 2), and a network of terms coming to have a high score is configured by the CPU system 2 of FIG. 1 and displayed on the display part 3 of FIG. 1 (step 5 of FIG. 2). Among the networks connecting the query 1 and the query 2 depending on a purpose of the user, the network having a degree of association with the highest score is displayed with emphasis (step 6 of FIG. 2). When the experimental results of the linkage analysis and the association study are available, a gene region, which is to be a candidate from the experiment results, is designated under the search conditions of the input part 3 by the input part 1 of FIG. 1 (step 2 of FIG. 2), and the query 2 is automatically specified the gene name of its region (step 3 of FIG. 2). In this case, the query 1 includes a disease name or the disease name and a symptom, but they are not exclusive. Besides, the term network connecting the query 1 and the query 2 is calculated a score and displayed together with a degree of association between each gene and a disease gene of the past information and the lod score of the experimental result to present a candidate gene region (step 7 of FIG. 2). And, specific relationships are clarified by displaying the terms configuring a network with a high score connecting the disease gene and the disease name (step 8 of FIG. 2). To use the array data, the result of clustering from the gene group (to be the query 2) to be the object and the expression information is input in the step 2. Through the same procedure as that described above, a misclustered gene candidate is presented according to the results of clustering using the network of terms for comparison in step 9.

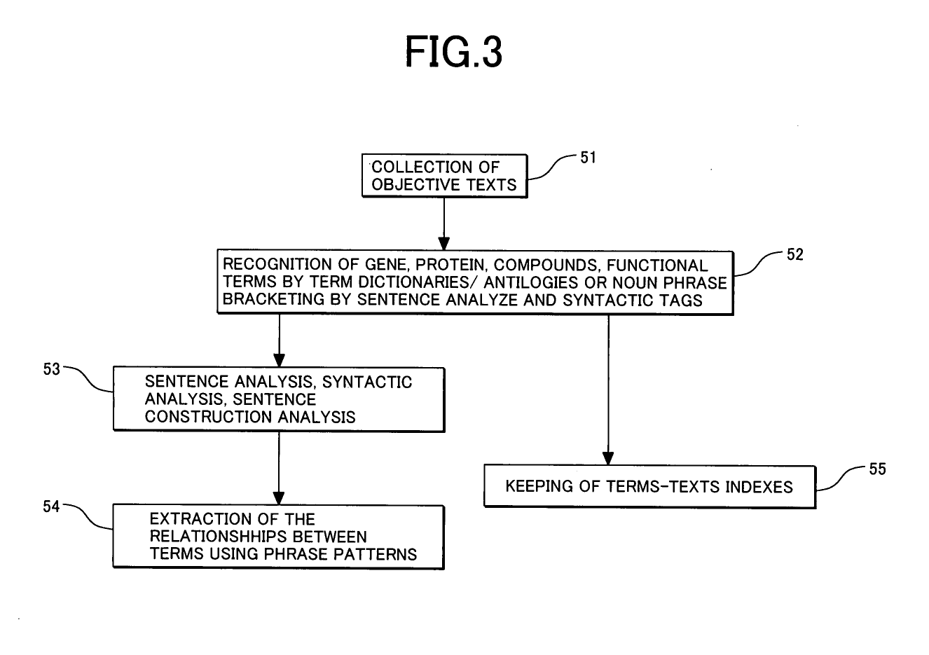

The data storage system 4 of FIG. 1 previously accumulates function information such as interactions, genes and proteins previously extracted manually or automatically extracted using a sentence pattern from texts as the binary relations (42, 43 of FIG. 1) and the interaction information and configuration function information (44) taken from other databases. To use the co-occurrence information on terms in the texts, the terms, the text including the terms and the positions of terms in the text are accumulated as a table (41). When terms to be the object are few, co-occurrence of all term pairs may be previously calculated as a weight of the binary relation and given in the table. A flow to automatically extract such information is shown in FIG. 3. The object data includes various kinds of science-specialized magazines, and magazines registered in NCBI (http://www.nlm.ncbi.nih.gov) PUBMED-abstract, PUBMED-central and the like. Object theses are desirably narrowed to only an abstract/thesis of living species to be the object using a mesh term when the PUBMED is used because information on other living species is not mixed. Connection to the data storage system may be made through the Internet.

Then, a method of extracting the relationship between terms will be described. As the term groups configuring the network, a manually controlled glossary/dictionary such as gene/protein names, compound names, gene ontology, UMLS (Unified Medical Language System), SNOMED (International: The Systematized Nomenclature of Medicine) and Mesh (Medical Subject Headings) or a combination of them is desirable, but all noun phrases and the like appearing in a text may be used as the terms. And, among all the noun phrases appearing in the text, only the noun phrases with a higher frequency of use than that of noun phrases appearing in another corpus to be an object such as newspaper or the like may be an object to the used terms. Otherwise, a term set may be extracted automatically from the target texts by use of a volume of mutual information with the adjacent base (e.g., Shimohata et al., ACL PP. 476-481, 1997), a C-value method (Maynard and Ananiadou, TKE PP. 212-221, 1999) and the like. And, a Boost strap method for automatically extracting the remaining terms (and local contexts) from the target texts by using a partial set of target terms and a local context where they tend to appear may be used to produce the term set (for example, Agichtein et al., 2001 2001 ACM SIGMOD International Conference on Management of Data).

Such terms desirably have synonyms, homonyms and the like solved as much as possible by using dictionaries and the like or by configuring a dictionary if necessary.

For the extraction according to a phrase pattern (sentence pattern), noun phrase bracketing is conducted by conducting a sentence structure analysis and a syntactic analysis, then the sentence structure is analyzed for insertion phrases, coordinate conjunctions and the like. And, the relationship among the terms is extracted by checking whether the target term is contained in the noun phrases according to “a noun phrase activates a noun phrase”, “a noun phrase interacts with a noun phrase”, “a noun phrase inhibits a noun phrase” and “an interaction between a noun phrase and a noun phrase.” For example, information, that protein-2 activates protein-1, can be extracted automatically according to a sentence that A domain of protein-1 is activated by B domain of protein-2. Strength of the relationship between two terms can be indicated by not only a describing frequency of the relationship but also the reliability at the extraction of the relationship can be indicated by using a distance of words between the terms, grammatical complexity and the like (for example, whether the extracted protein name is positioned behind the preposition or a particular term in the noun phrase, or the like). Before the sentence structure analysis or syntactic analysis, preprocessing such as conversion of the object term into ID or noun bracketing of a technical term consisting of plural words may be conducted if necessary in order to improve the analysis accuracy.

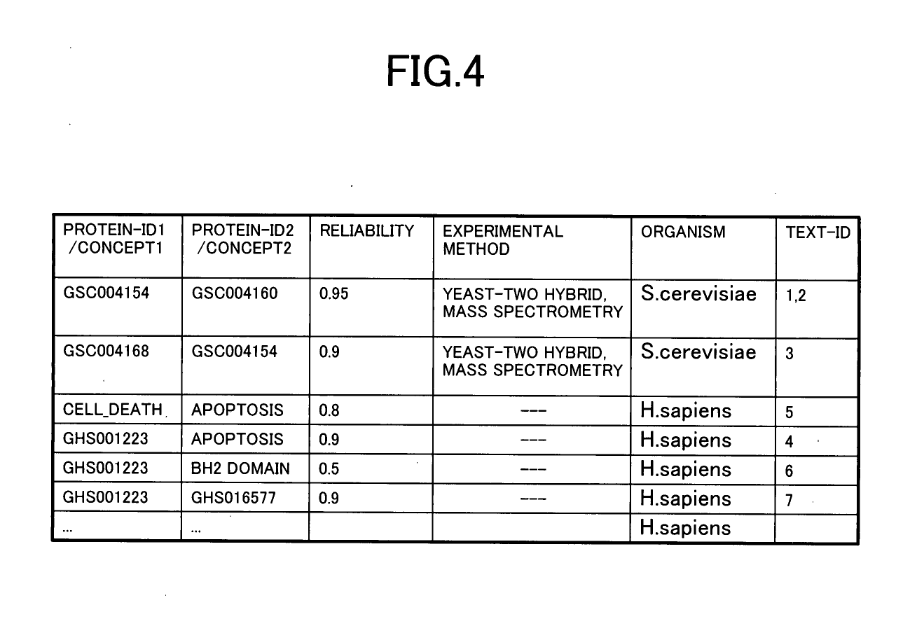

Various methods are available for extraction of the relationship between terms, and the extraction is not limited to the above. An example of the information extraction according to a phrase pattern is shown in FIG. 4. In the figure, the binary relations are indicated as reliability at the extraction. Here, the reliability is determined according to whether a particular preposition is positioned before a noun phrase containing a gene and a kind of phrase pattern having extracted the relationship. A weight of information, an experiment method, text information as the source for the information, and the like are affixed as the attributes to the binary relation itself.

To determine the co-occurrence relationship between terms, a volume of mutual information between terms and the like can be used, but it is not an exclusive method because there are various methods available. The volume of mutual information between terms is determined by log (Fab*N/Fa/Fb) when it is assumed that Fab=the number of unit texts in which term A and term B co-appear, Fa=the number of unit texts in which term A co-appears, Fb=the number of unit texts in which term B appears, and N=total number of unit texts. And, Fablog (Fab*N/Fa/Fb) (entropy gain), which is the product of the above value and Fab, is also effective. Besides, when it is assumed that PHGS (N, n, K, k) is a probability value that at least k red balls are included when n balls are removed at random from a bag containing N balls including K red balls, a value of −log (PHGS (N, Fa, Fb, Fab)) and its symmetrical −log (PHGS (N, Fa, Fb, Fab))−log (PHGS (N, Fb, Fa, Fab)) are also effective co-occurrence scales. As a unit text, setting falling in a range of prescribed words can be made regardless of a structural unit or configuration in a range (single sentence) or the like under the control of a whole text, a chapter, a section, a paragraph, a sentence or one word. Strength of the relationship between two terms can be uniquely determined from such expressions.

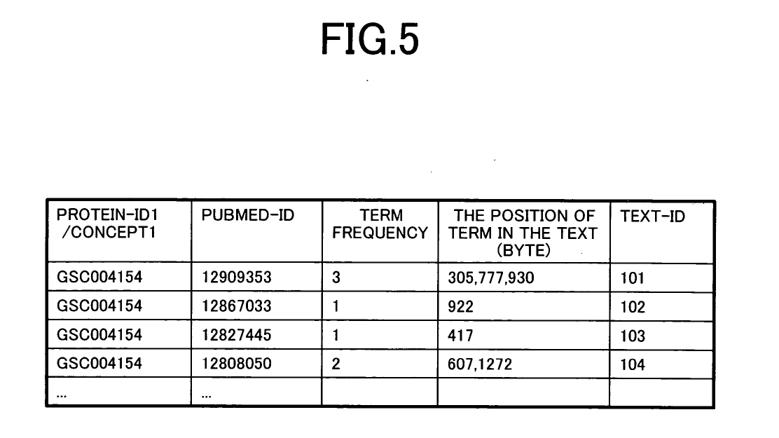

The co-occurrence relationships between terms may be calculated previously and listed as a table but may be calculated dynamically by the CPU system of FIG. 1. An example of terms and their text information is shown in FIG. 5.

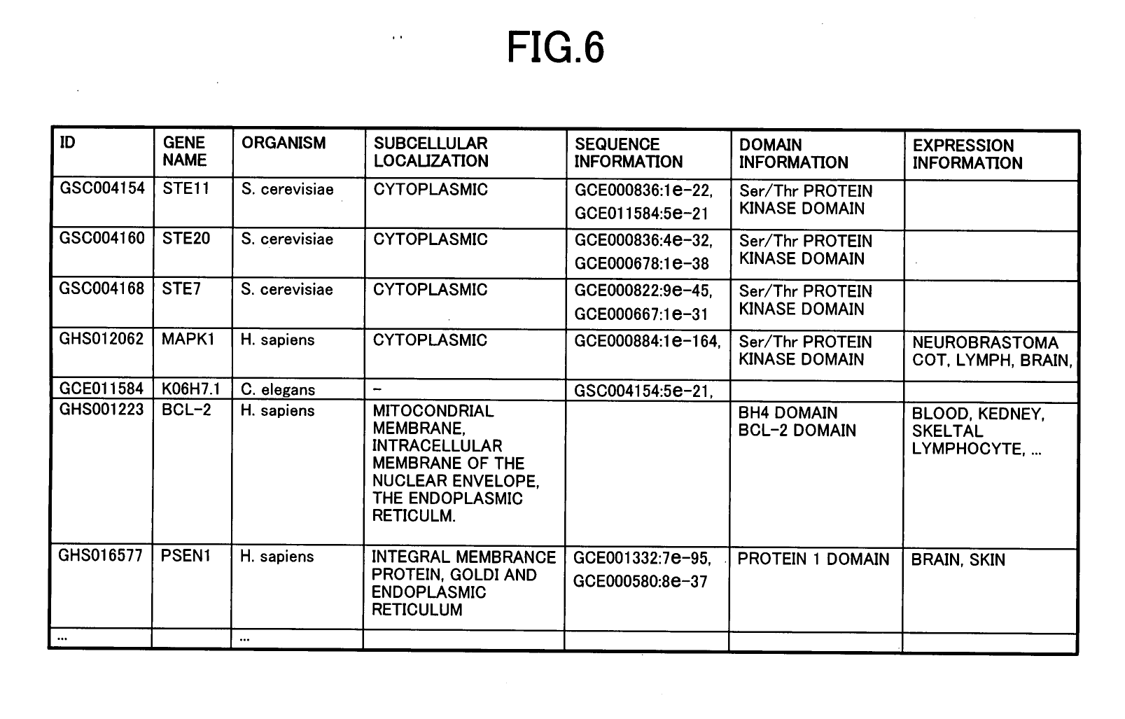

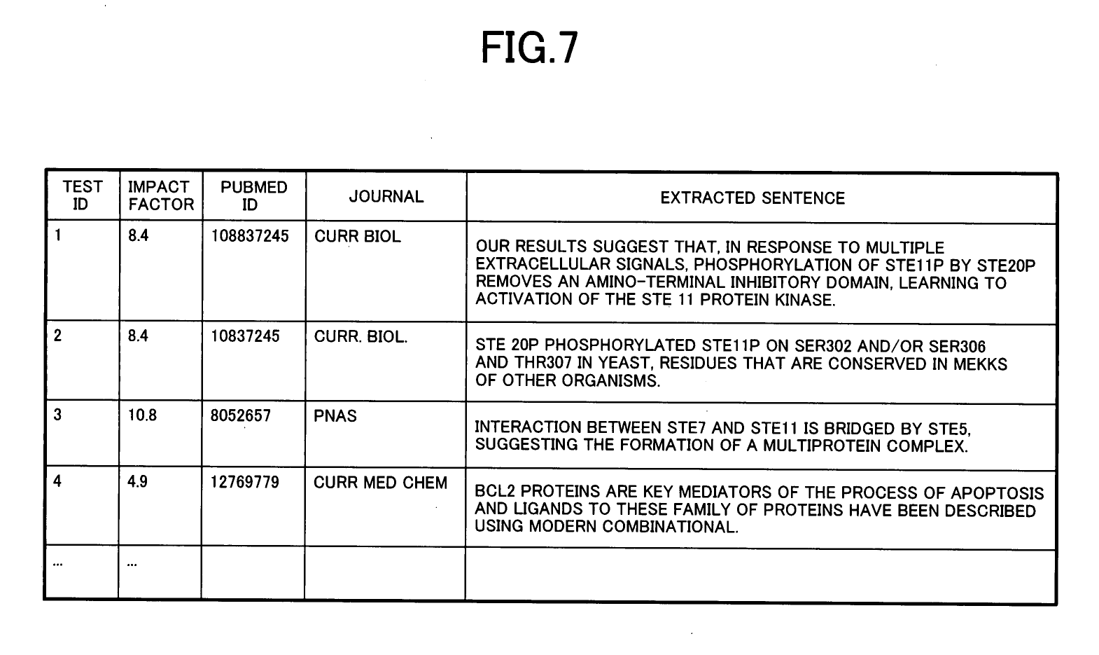

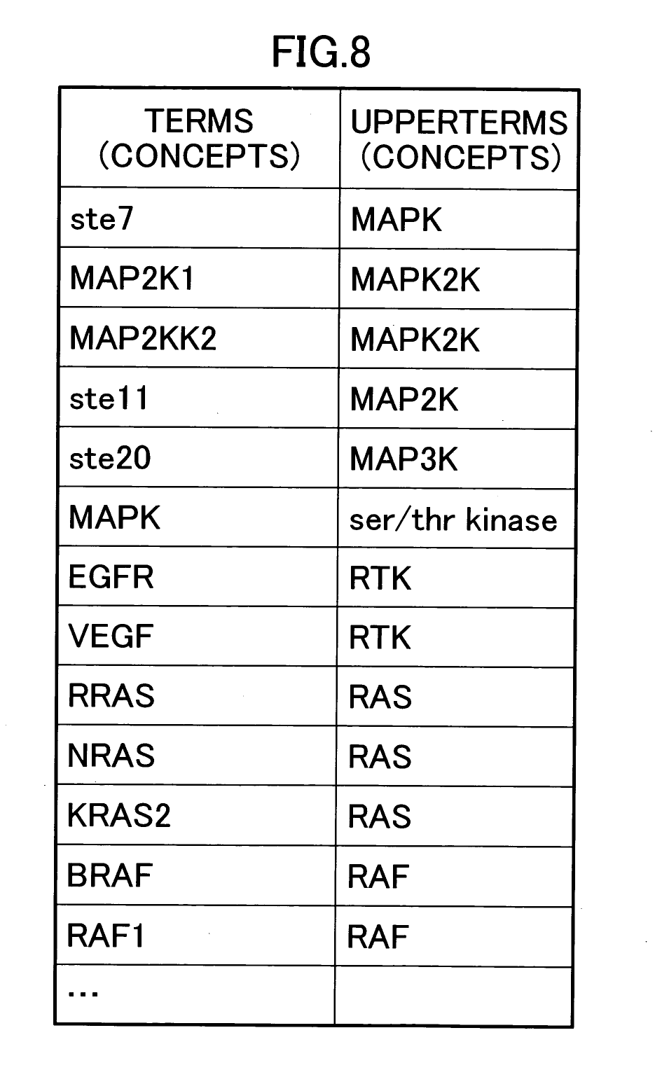

Expression information and subcellular localization information of genes are attached as the attributes to the terms configuring the relationship. An example of E-value (an expectation value indicating how many arrays of the same similarity appears accidentally within the database) indicating as the attributes the subcellular localization and sequence similarity is shown in FIG. 6, and text information is shown in FIG. 7. When the term itself is a concept that makes a hierarchy structure, its information is also attached to the data storage system 4. Its example is shown in FIG. 8. The attributes such as the expression information and localization information may be accumulated from not only the texts used for the extraction of the relationship but also information on the other experiment results. A weight of information here indicates a frequency of appearance when co-occurrence is used, the reliability and the number of times of appearance at the above-described extraction when a phrase is used, or 1 across all when the extraction is made manually, indicating a degree of association between the terms. Where plural different extraction data are to be used, normalization shall be made if necessary so to provide consistency between data. This weight will be called as the score below. It is also possible to perform the following calculation while dynamically accumulating the relationship between terms from an outside database through the Web or the like.

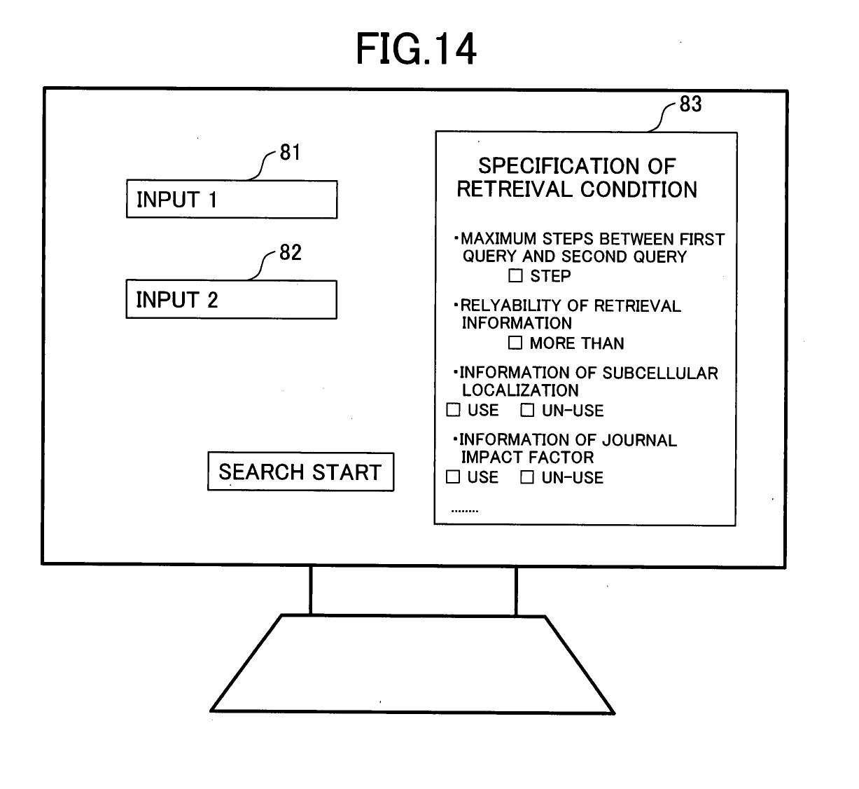

The query input part 1 comprises two query groups of the query 1 and the query 2 and another retrieval and drawing condition setting department. The screen of a specific input device is shown in FIG. 14. The search screen has windows 81, 82 for inputting the queries 1, 2 and a window 83 as a third input part for designating search conditions. The third input part can designate a distance between terms, the number of candidates from a high score side, use of a highlight line depending on the degree of association, a type of data set storing the relationship between terms, information on the reliability of data, the maximum steps connecting the queries 1, 2, and the like. Where a compound word with a space is input in the queries 1, 2, it is put in ‘ ’ or “ ” or connected with an under bar (_) or the like. Where plural queries are designated, they can be divided by a space before being input. As the input method, there are various ways available, so that it is not limited to the described one.

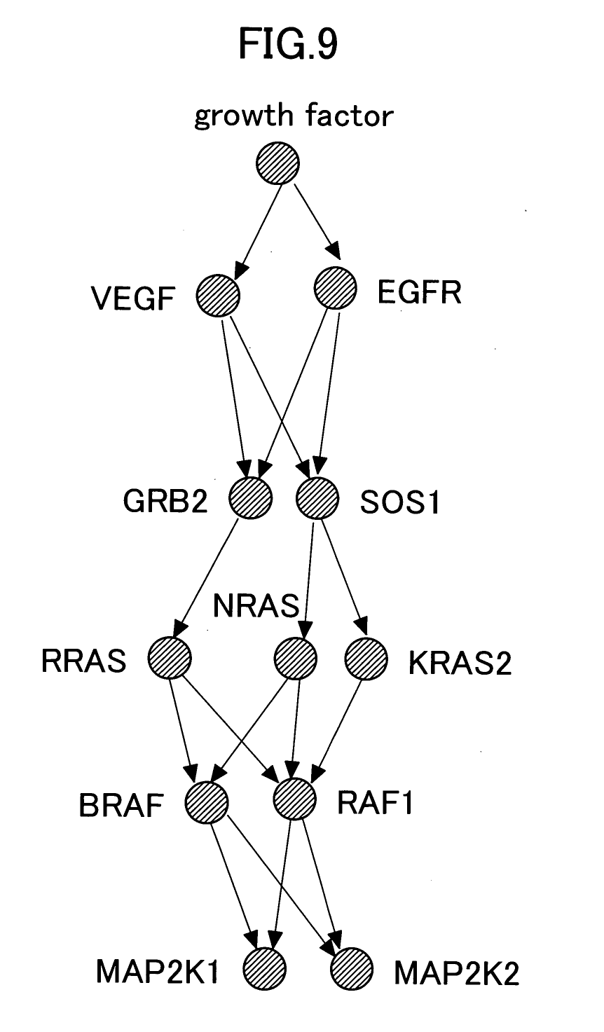

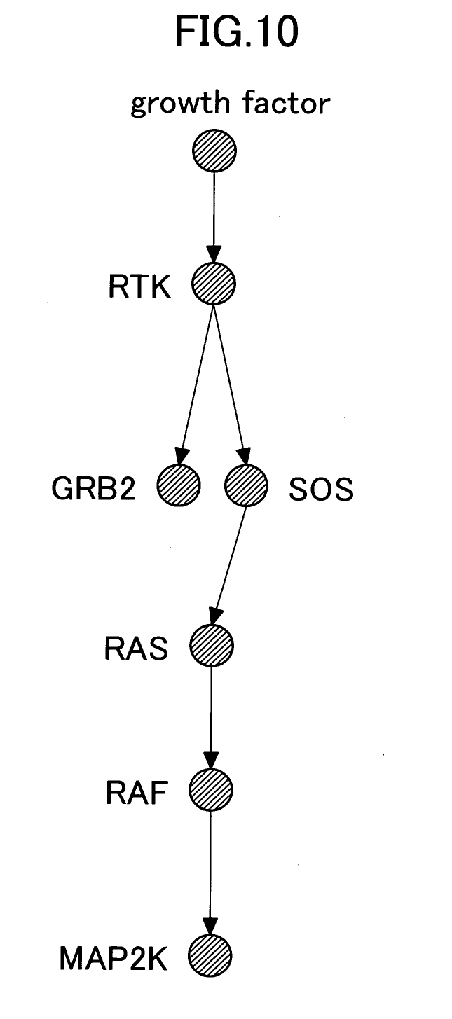

The query 1 and the query 2 are mainly designated in response to the demands made by the user for a gene/protein/compound and its function, a disease name, a symptom or the like. Both the query 1 and the query 2 are comprised of at least one term. The CPU system uses a score indicating the degree of association between terms to calculate the term belonging to the query 1 and the query 2 according to the sum total of scores/(the number of edges\hat{ }1.1) or a function comprising another score and edge and a high score of term network candidate connecting the query 1 and the query 2 by a dijkstra method, an evaluation and review technique or the like. Because the highest score is not always the best network, the number of candidates under the search conditions designated through the input part 3 by the user is calculated at the same time. When the data set subject to the calculation of the network is made of a hierarchical concept, the term network can be written with the upper hierarchy designated by the user through the input part 3 of FIG. 1. Its example is shown in FIG. 9 and FIG. 10. The network complicated in FIG. 9 becomes simple in FIG. 10, which is easy to understand by drawing according to an upper concept (term). Drawing according to the upper concept might mean a relaxation of the drawing conditions. For example, when relationships between RRAS and RAS1 and between RAF1 and MAP2K1 only are designated in FIG. 9, the relationships between RRAS and MAP2K1 is not extracted. But, in the upper concept, RAS and MAP2K are associated because RAS and RAF and RAF and MAP2K are associated according to the information.

Besides, the user can interactively set the drawing conditions through the input part 3 of FIG. 1. For example, the user can designate a type of data set used for the term net, screening according to the reliability of data, and the like. Examples of screening excludes the results of a mass-experimental technique, yeast-two hybrid and mass spectrometry because their reliability is low or what is described in scholarly books has a low impact factor. The impact factor here includes not only the value calculated by Institute for Scientific Information but also the values calculated by other groups and institutes. To exclude an automatic extraction error from the texts, the automatic extraction according to the phrase patterns may on the condition that there are at least prescribed quantity of text information. In addition, when interaction information between protein-protein/DNA/RNA is used among the binary relation information, the network can be configured with the binary relation which has considerably different subcellular localization (e.g., one is nuclear protein and the other is mitochondrial protein) excluded in order to eliminate an experimental error. It is also possible to use only genes/proteins appearing in particular cells to configure the network. For example, there are at least ten genes, which interact with BCL-2 of H. sapiens, now but their quantity decreases when limited to a particular organization. When the focused organization is lymphocyte, PSEN1 which is known as the gene interacting with BCL-2 has not been reported about expression information in lymphocyte so far, so that the relationship between BCL-2 and PSEN1 is not used for the construction of a network of terms.

Besides, the user can use the editing function on the screen to remove a possibly unnecessary edge (a line connecting a term and a term) or the term itself in the drawn network or to conversely add an edge or the term itself and recalculate the network.

When information on genes and proteins is little in connection with the focused living species, it is also possible to use information on other living species and array similarity to construct the network of terms in the same way. For example, it is also possible to use information corresponding to the sequence similarity of FIG. 6 to construct a network ranging from S. cerevisiae to C. elegans. And, using the top score or threshold of E-value, a corresponding gene may be found, and loose conditions such as domain information may be also used depending on the purposes so to bring proteins/genes into correspondence between the living species. In FIG. 4 and FIG. 6, for example, the relationship between STE20 and STE11 of S. cerevisiae is projected to the relationship between GCE000836 (mig-15) and GCE000678 (kin-18) of C. elegans when the top score is used.

### EXAMPLE 2

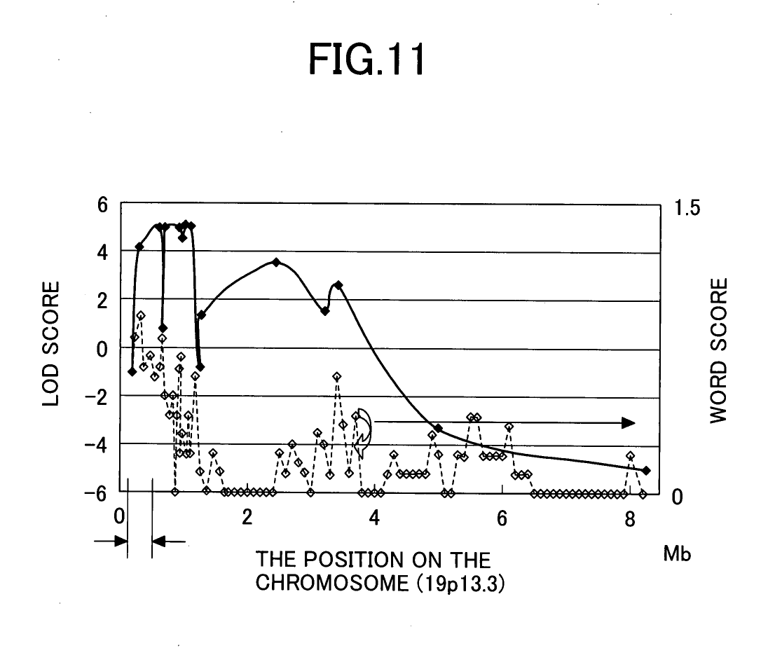

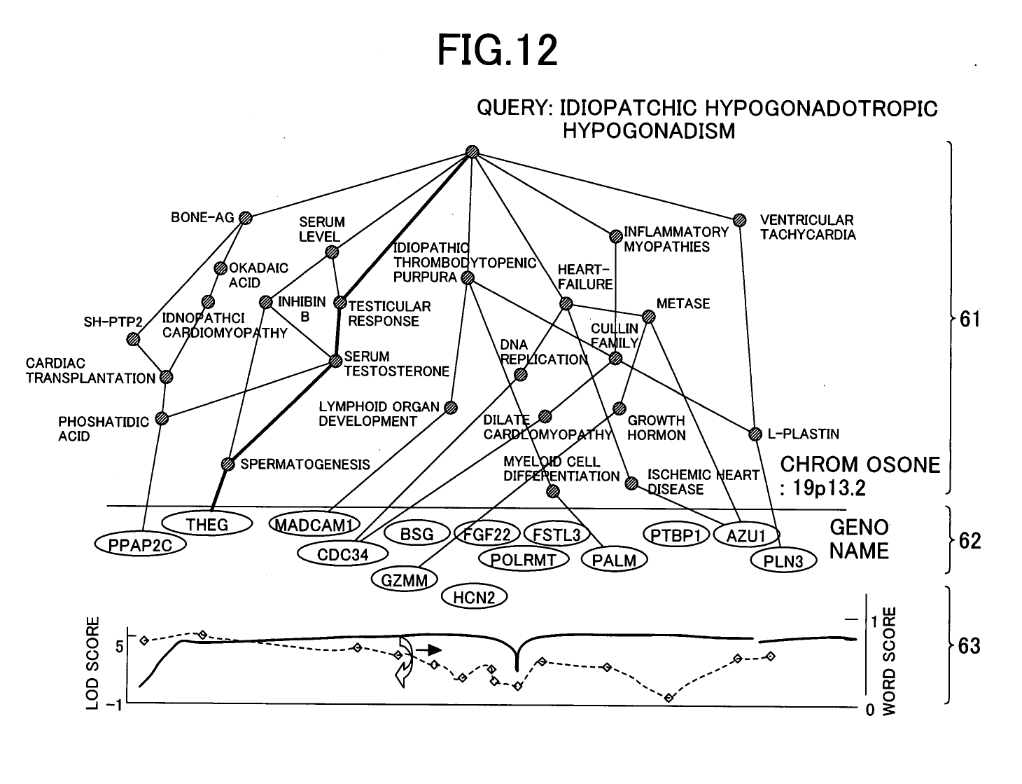

As to the use for the result of linkage analysis, an example that the gene causing idiopathic hypogonadotropic hypogonadism is considered present in chromosome 19p13.2 will be described with reference to FIG. 11 and FIG. 12. The result of linkage analysis is according to J. S. Acierno et al., The Journal of Clinical Endocrinology and Metabolism 88(6), pp. 2947-2950, 2003. The analyzed result of q=0.05 is indicated in a solid line in FIG. 11 (for meaning of q, see the linkage analysis in Handbook of statistical genetics, edited by D. J. Balding et al., Wiley, England 2001). A dotted line indicates the score of the network between terms calculated from the co-occurrence relationship of noun phrases in the abstract registered in PUBMED of human 1980-2003 with the query 1 determined as idiopathic hypogonadotropic hypogonadism. As a result, the positions of 0.2-0.4 Mb where they have a peak are presented in step 7 of FIG. 2 (a portion covered by the arrow in FIG. 11) (here, 0.2 Mb was determined as the position of marker rs7815). And, an example of the network of terms in step 8 of FIG. 2 is shown in FIG. 12. In FIG. 12, a second category is the gene name, and the horizontal axis on the screen indicates the gene name (62), showing an example that the first and second queries are displayed in a network form through plural terms on the screen (61). In addition, a lod score is also shown together with a term score on the network display (63), and the lod score is shown for each gene on the horizontal axis or together with information on chromosome positions. Here, there is shown an example that a region of 0.2-0.4 Mb which is considered convincing in view of the lod score and text information selected in step 7. The term network having the highest score is indicated in a solid line. The lod score is described in detail by Onda et al., Stroke, 34(7), pp. 1640-1644, 2003.

In this example, when the line segment connecting terms is clicked, information on data stored in the data storage system, for example, a magazine name, a sentence, an abstract, a database name or the like, which is the source of data indicating the relationships between terms, can be shown. When a node is clicked, the attributes of a term can be shown. It may be linked to the Internet to extract information.

### EXAMPLE 3

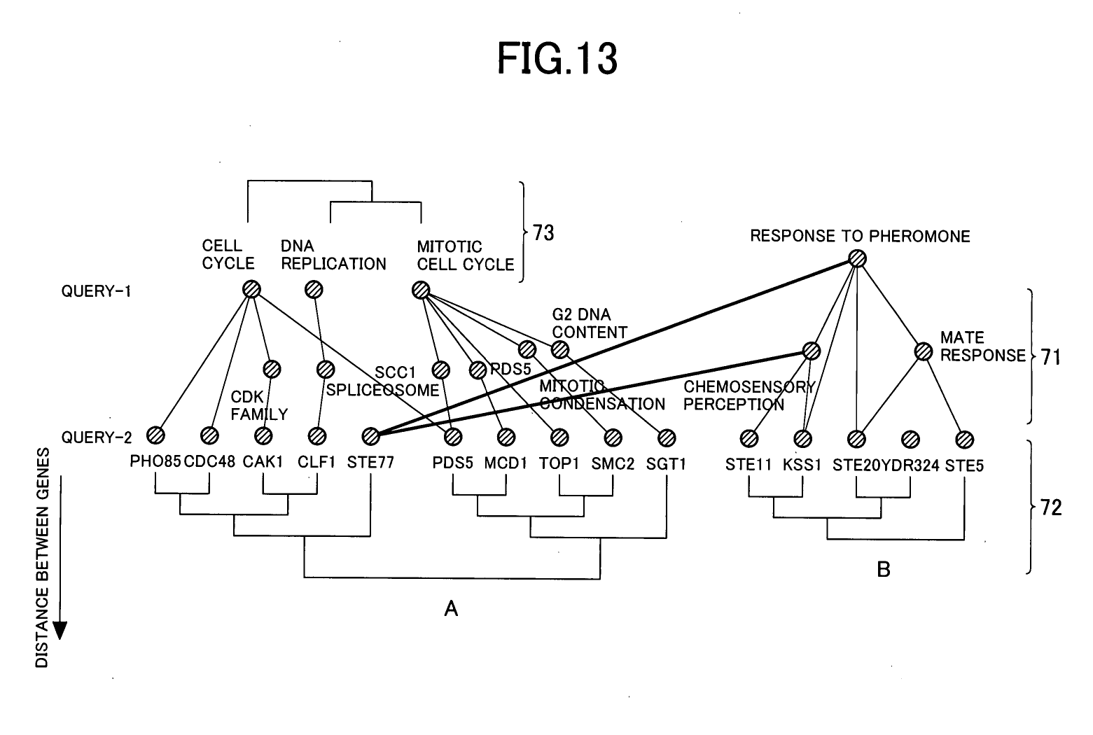

An example of the term network when data on appearance of a DNA-array is used is shown in FIG. 13. It corresponds to step 9 of FIG. 2. In FIG. 13, an upper section 71 shows a portion linking a gene group used in clustering corresponding to the query 1 and the query 2 by a network of terms. A lower section 72 shows an example of clustering according to the experimental results in which a hierarchical clustering based on expression data of DNA array is shown. The query 1 includes all terms classified into the biological process of gene ontology, and the query 2 describes the network of terms when the gene names clustered are included into the same group by the expression data. In this example, the terms of the query 1 not showing a significant network are not shown (an upper section 71). A hierarchical structure of query 1 terms on the dictionary side of a cell cycle, a DNA replication and a mitotic cell cycle is shown in an upper section 73. According to the experimental data, STE7 belonging to cluster A is different from genes belonging to another A, does not have a network significant with the terms relevant to the cell cycle but has a network with a response to pheromone. Therefore, it is miss clustering caused by the experiment noise, and it is suggested that it originally belongs to cluster B. It is preferable that the network and genes that become candidates for the miss clustering are highlighted because the array data covers a lot of genes. On the other hand, it is suggested that YDR324 is possibly a new gene not having a network with a response to pheromone but related to the response to pheromone without having a significant network with other terms.

When the query is made plural, it has a role of preventing a leak of the network. Especially, if sufficient texts are not available, the effect of having the plural queries is great. For example, at the CLF1, the relationship with DNA-replication can be extracted from the texts but the direct relation with the cell cycle cannot be extracted. The relation between DNA replication and the cell cycle can be extracted from the texts, and there is no problem, but even a concept of a hierarchical relationship of terms (concepts) such as hemolysis and apoptosis, the relationship of terms hardly extracted due to co-occurrence or the like is overlooked. Therefore, when the apoptosis relation is desired to be set on the query 1, the network of terms can be constructed more securely by including both apoptosis and hemolysis into the query 1 without suffering from a leakage.

According to the above-described example, it is often that the number of genes does not become smaller than 100 in a region where a disease candidate appears by a linkage analysis, association study, or the like, and it takes an enormous time when a person reads each thesis to make sure such gene information. And, when genes not in one's field are broadly handled, background knowledge is insufficient, and there is a possibility that the right answer (disease gene) cannot be found because the relationship between two concepts/terms is not known. The relationship between a candidate gene and a disease can be found by this method in a short time, and the procedure can advance to the next necessary experiment.

And, it is known that data on the DNA array and protein array contains lots of noises, and it is not easy to perform clustering of genes according to the expression data at high precision. Using this network of terms, a gene to be a misclustering candidate because of a noise can be found easily among genes of which functions are already known.

### EXAMPLE 4

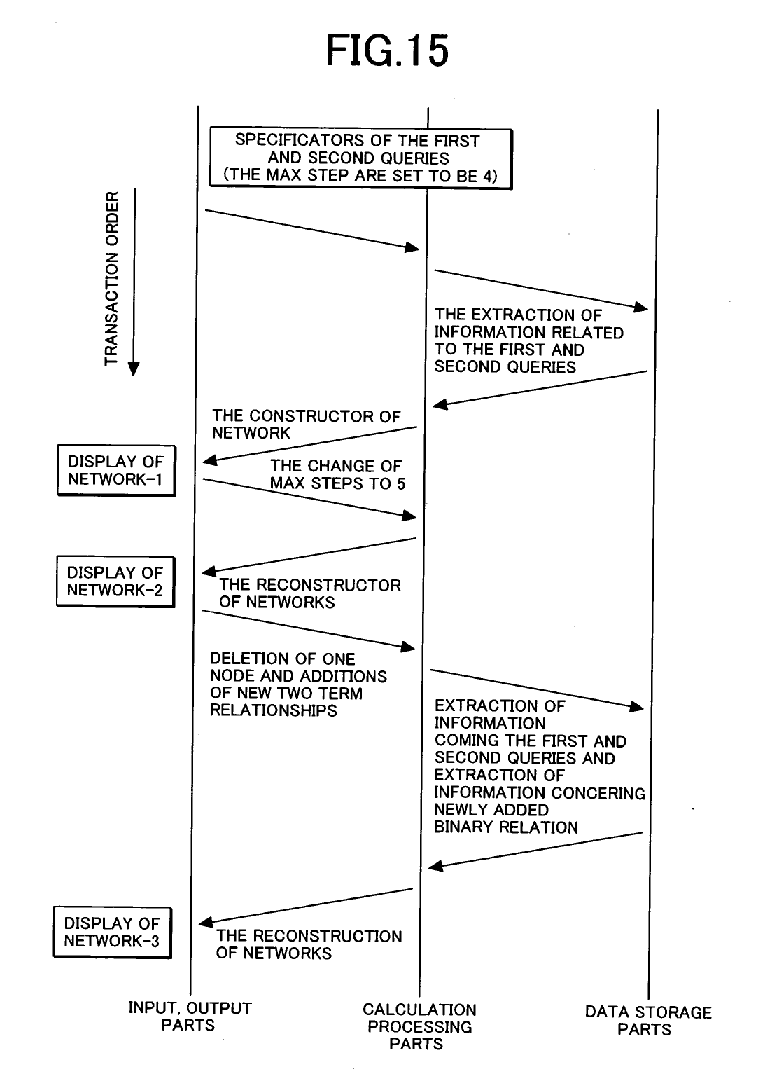

In this example, interactive specification of retrieval conditions will be described with reference to FIG. 15. It is assumed in this example that the maximum steps of the network connecting the first and second queries are first designated to be 4. A calculation processing part interactively takes information on the first and second queries from the data storage system to construct the network and sends the coordinates of its node and edge information to the output part to display a network-1. When the user sees the results to find that the expected relationship is not obtained, the user designates a change in the maximum steps of drawing (it is changed to 5 in FIG. 15). The calculation processing part recalculates the network, and the output part displays a network-2. Extra nodes are shown on the screen when displayed again, and when the user considers what will happen by assuming another binary relation, the pertinent node is removed from the screen, and the relationship between two terms is newly assumed to designate drawing. The calculation processing part takes information on the newly added binary relation in addition to the first query information from the data processing part, calculates a network while considering the removed node information and shows a network-3 at the output part. Addition and deletion of the node and addition and deletion of the edge (binary relation) may be conducted on the screen of the network by Java (registered trademark)—applet's function or the like or can be input in a text form shown in FIG. 14.

Here, the calculation processing part and the data storage system interactively exchange data, and when the data is adequately small, all the data may be placed on the memory of the calculation processing part to conduct the same processing at the start of the system.

To construct the term network connecting the first query and the second query, gene/protein which has not appeared in the focused organization may be set to be unusable. Naturally, such setting can be made interactively.

To construct the term network connecting the first query and the second query, as indicated by the specification of retrieval condition 83 in FIG. 14, it can be configured so that the lower limit value of the impact factor in a scholarly book as the source of the description as grounds for the association of terms can be set, and the relationships between terms extracted from the scholarly book having the above value or more is used to construct the network. It is naturally advisable to make this setting interactively.

And, to construct the term network connecting the first query and the second query, an experimental method as a ground for the association of terms may be configured so to make interactive data, which was found by an experimental method (Yeast-two-hybrid, mass spectroscopy, etc.) having a tendency to produce a large volume of data with a low degree of reliability, unusable, so that noise can be reduced. It is naturally advisable to make this setting interactively.

The present invention can also be used to search for information on other categories in addition to the research for biological information described in the examples.

It should be further understood by those skilled in the art that although the foregoing description has been made on embodiments of the invention, the invention is not limited thereto and various changes and modifications may be made without departing from the spirit of the invention and the scope of the appended claims.

1. A network drawing system, comprising:
a first input unit designating a first query belonging to a first category;
a second input unit designating a second query belonging to a second category;
a data storage device storing a degree of association between terms belonging to a third category containing the first category and the second category in the form of a plurality of sets of tables;
a calculation device which associates the input first query and second query through a plurality of terms, using the table stored in said data storage device; and
a display device displaying on a screen of a network of terms having connected the first query and the second query through the plurality of terms based on a result of calculation made by said calculation device.

2. The network drawing system according to claim 1, further comprising a third input unit for designating a drawing condition; and
said network being displayed according to said drawing condition.

3. The network drawing system according to claim 1, wherein said data storage device further stores attributes of said terms.

4. The network drawing system according to claim 1, wherein at least one of said first query and said second query is plural.

5. The network drawing system according to claim 1, wherein among routes connecting said first query and said second query, a route having the highest degree of association between the terms is displayed by a highlight line.

6. The network drawing system according to claim 1, wherein
said first category is at least one of a disease name, a symptom, a protein name, a gene name, a compound name, a gene function and a protein's function; and
said second category is at least one of the compound name, the protein name and the gene name.

7. The network drawing system according to claim 1, wherein
the association between said terms is extracted according to co-occurrence between terms or phrase patterns.

8. The network drawing system according to claim 1, wherein
the network between terms is re-displayed interactively by changing the setting of said third input unit.

9. The network drawing system according to claim 1, wherein
the connection between terms or editing for addition or deletion of a term itself can be conducted interactively by changing the setting of said third input unit.

10. The network drawing system according to claim 1, further comprising a synonym dictionary for converting at least one query input through said first input unit or said second input unit into a standardized term.

11. The network drawing system according to claim 1, wherein
the association between said terms is displayed on the screen at the same time.

12. The network drawing system according to claim 1, wherein
when said term has a hierarchy, said term is displayed hierarchically.

13. The network drawing system according to claim 1, wherein
said second category is a gene name, and said gene name is displayed along a horizontal axis of said screen, and a lod score is displayed for each gene of the horizontal axis or together with information on a chromosome position.

14. The network drawing system according to claim 1, wherein the association between said terms is displayed together with the result of gene clustering.

15. The network drawing system according to claim 1, wherein
when a result of displaying the network does not match with a result of the gene clustering, a route connecting the first query and the second query which do not match with each other is displayed by a highlight line.

16. A network drawing method, comprising the steps of
inputting a first query belonging to a first category into a first input unit;
inputting a second query belonging to a second category into a second input unit;
using a data storage device having a degree of association between terms belonging to a third category including said first category and said second category stored in the form of a plurality of sets of tables to associate said input first and second queries through a plurality of terms; and
displaying on a display device a network of terms having connected said first query and said second query through said plurality of terms according to a result of said associating.

17. The network drawing method according to claim 16, comprising connecting to said data storage device through an Internet.
